(19) United States
(12) Patent Application Publication
(10) Pub. No.: US 2026/0064268 A1
(43) Pub. Date: Mar. 5, 2026

(54) METHODS AND APPARATUS TO COMPRESS AND DECOMPRESS DATA

(71) Applicant: The Boeing Company, Arlington, VA (US)

(72) Inventors: Benjamin Horn Oster, Media, PA (US); Eric Russell Fox, Philadelphia, PA (US); Rachel Nelson, Philadelphia, PA (US)

(21) Appl. No.: 18/818,139

(22) Filed: Aug. 28, 2024

(51) Int. Cl. G06F 3/06

(52) U.S. Cl. CPC G06F 3/0608; G06F 3/0655; G06F 3/0679

(57) ABSTRACT

Disclosed examples include accessing a listing of time values; accessing first compressed instrumentation data and second compressed instrumentation data during a runtime of an application in response to a request from the application; decompressing the first compressed instrumentation data during the runtime to generate first uncompressed instrumentation data in alignment with the time values; and decompressing the second compressed instrumentation data during the runtime to generate second uncompressed instrumentation data in alignment with the time values.

### FIELD OF THE DISCLOSURE

This disclosure relates generally to computers and, more particularly, to methods and apparatus to compress and decompress data.

### BACKGROUND

Compressed data reduces the amount of memory capacity used for data storage. A computer can decompress the data to generate uncompressed data.

### BRIEF DESCRIPTION OF THE DRAWINGS

FIG. 1 is an example environment in which an example data compressor operates to compress data and an example just-in-time (JIT) data decompressor operates to decompress data.

FIG. 2 is an example object-of-objects data storage framework to store multiple child objects in a parent object in object-oriented programming.

FIG. 3 is an example child object of the object-of-objects data storage framework of FIG. 2.

FIG. 4 is an example properties listing of the signal data child object of FIG. 3 before data decompression.

FIG. 5 is the example properties listing of FIG. 4 of the DR signal data child object of FIG. 3 after performing data decompression.

FIG. 6 is an example signal-to-time map showing multiple instrumentation signal data child objects associated with a single listing of time values.

FIG. 7 is a block diagram of an example implementation of the data compressor of FIG. 1.

FIG. 8 is a block diagram of an example implementation of the JIT data decompressor of FIG. 1.

FIG. 9 is a flowchart representative of example machine-readable instructions and/or example operations that may be executed, instantiated, and/or performed by example programmable circuitry to implement the data compressor of FIG. 7.

FIG. 10 is a flowchart representative of example machine-readable instructions and/or example operations that may be executed, instantiated, and/or performed by example programmable circuitry to implement the JIT data decompressor of FIG. 8 to selectively access uncompressed instrumentation data from the object-of-objects storage framework of FIG. 2.

FIG. 11 is a flowchart representative of example machine-readable instructions and/or example operations that may be executed, instantiated, and/or performed by example programmable circuitry to implement the time handler of FIG. 1 to retrieve listings of time values corresponding to uncompressed data.

FIG. 12 is a flowchart representative of example machine-readable instructions and/or example operations that may be executed, instantiated, and/or performed by example programmable circuitry to implement the JIT data decompressor of FIG. 8 to access uncompressed data.

FIG. 13 is a block diagram of an example processing platform including programmable circuitry structured to execute, instantiate, and/or perform the example machine-readable instructions and/or perform the example operations of FIGS. 9-12 to implement the data compressor of FIG. 7 and/or the JIT data decompressor of FIG. 8.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale.

### DETAILED DESCRIPTION

Compressed data reduces a data size of a corresponding file. A computer decompresses the compressed data to enable use of the corresponding original data. Prior data compression and decompression techniques produce memory-intensive applications and/or slow performance. For example, a memory-intensive application can decompress all of the compressed data of a file into system memory (e.g., Random-Access Memory (RAM)). However, when such decompression leads to a large amount of data that consumes a large portion of the system memory capacity, allocating such a large portion of the system memory to the decompressed data can lead to negative performance of the computer. Such negative performance is compounded when computers such as mobile computers (e.g., laptop computers, tablet devices, mobile phones, etc.) are equipped with smaller system memory capacities relative to more powerful stationary computers.

Some prior systems allow decompressing only specifically requested data such as in database applications. However, searching for and accessing particular data records in a database is time-consuming and produces a user perception of slow performance when accessing requested data for analysis.

Examples disclosed herein may be used to implement an object-of-objects data storage framework to store compressed data and perform object-oriented just-in-time (JIT) decompression that selectively decompresses specific portions of the compressed data without decompressing other portions. As used herein, an object is an instance of a class in object-oriented programming such that the object includes data and/or other information structured according to its corresponding class definition. A class definition does not consume memory. However, when an object is instantiated based on that class definition, memory is allocated to the object so that data can be stored in the allocated memory in association with the object.

The object-of-objects data storage framework and the object-oriented just-in-time decompression process disclosed herein reduces storage capacity used by instrumentation data, reduces memory capacity used by computers during application runtimes, and increases the speed at which a computer can present decompressed data from a source of compressed data.

For example, when data is requested from a file of compressed data, examples disclosed herein can be used to load the file of compressed data into memory so that the smaller data size of the file's compressed data state allows the file to use less memory capacity than if the entirety of the compressed data were decompressed into memory.

Examples disclosed herein enable maintaining minimized memory use by decompressing only select portions of the compressed data in the file just-in-time at the moment a request is received (e.g., from a user or a high-level method) to access such data during an application runtime. As such, while an incremental amount of system memory capacity is used to store the selected portion of the compressed data in its uncompressed state, the other portions of the compressed data remain stored in their compressed state in the system memory. When the decompressed data is no longer in use, it can be discarded or marked for overwrite in the system memory to re-allocate system memory capacity for other uses.

In addition, leaving data in its compressed state when loading a file into system memory decreases the file loading time compared to decompressing the files contents as part of the file load process. For example, if a file is being accessed at a client computer from a server over a network, loading the compressed file into the client computer involves transferring less data over the network than would be used if the file contents were decompressed at the server and the decompressed data were transferred over the network to the client computer. In addition, the object-of-objects data storage framework and the object-oriented just-in-time decompression techniques disclosed herein enable data analysis, plotting, and other data processing capabilities to be integrated directly into objects (e.g., data objects) themselves to improve workflow efficiency during data analysis.

Incremental data decompressions using examples disclosed herein provide users and methods access to data in substantially real time with relatively less delay and less memory capacity usage while making the decompression and data access processes seamless to end-user perception. As such, examples disclosed herein improve the efficiency of a computer by decreasing the amount of time it takes for the computer to produce requested uncompressed data. In addition, by selectively decompressing data from a file without decompressing the entire file's data, examples disclosed herein improve the use of computer memory by decreasing the amount of memory used by the file when loaded into the memory.

During flight sessions, such as flight simulator sessions or actual flight sessions, a flight simulator software application or a flight recorder can generate multiple listings of instrumentation data (e.g., dependent variable data) and corresponding listings of time data (e.g., independent variable data) as aircraft flight data. Each listing of instrumentation data represents a different instrumentation signal of an aircraft. Examples of such instrumentation signals include an airspeed waveform signal, an altitude waveform signal, a pitch attitude waveform signal, a roll attitude waveform signal, a yaw attitude waveform signal, an air temperature waveform signal, etc. The instrumentation signals are generated over time during the flight session. As such, each instrumentation signal is aligned with time values of the time data to represent variations in the instrumentation signals over time.

Using examples disclosed herein, data values of instrumentation signals recorded during a given flight session can be compressed and stored in respective child objects of a parent object and an object-of-objects data storage framework. For example, the parent object can represent the flight session and each child object of the parent object is a separate data record holding compressed instrumentation data of a different one of the recorded instrumentation signals. In addition to compressing the recorded instrumentation signal data, the example object-of-objects data storage framework disclosed herein reduces the amount of data used to represent independent variable data such as time data that is common to multiple ones of the compressed instrumentation signal data. For example, for ones of the instrumentation signals recorded against the same time data, the example object-of-objects data storage framework stores a single instance or listing of time values in association with a time handle or pointer. As such, examples disclosed herein can be used to substantially decrease or eliminate duplications of time data stored in an object-of-objects parent object.

During subsequent analyses, the just-in-time decompression techniques disclosed herein can be used to selectively decompress requested instrumentation signal data in corresponding child objects of an object-of-objects parent object without decompressing non-requested instrumentation signal data of other child objects. During a requested decompression, the disclosed just-in-time decompression techniques use the time handle or pointer to align the associated multiple ones of the instrumentation data signals with the same corresponding single listing of stored time values.

Selective decompression examples disclosed herein can be performed on specific compressed data in an object-of-objects parent object to consume only an incremental amount of system memory capacity to store the decompressed data in response to a request at application runtime. Accordingly, examples disclosed herein can perform decompression faster by decompressing only portions of compressed data instead of the entirety of the compressed data. In addition, examples disclosed herein can minimize use of memory capacity while the selected decompressed data is used to perform different analyses such as signal plotting, filtering, modeling, statistical analyses, mathematical processing, etc. As such, examples disclosed herein reduce time spent by computers and users to load data into analysis tools and processes. In addition, examples disclosed herein reduce system costs by reducing the amount of storage resources and memory resources consumed by storing data and loading data in computers. Examples disclosed herein improve storage resource and memory resource scalability by minimizing storage and memory resource footprints, scaling out during times of higher compressed data traffic, and scaling in during times of lower compressed data traffic.

Although examples disclosed herein are described in connection with flight instrumentation data (e.g., flight simulation instrumentation data or actual flight instrumentation data), examples disclosed herein may be used in connection with any other type of data. For example, examples disclosed herein may be used to compress, store, retrieve, and perform just-in-time decompression of any type of data. When such other types of data include a common independent variable, common independent variable data can be de-duplicated when storing corresponding compressed data by storing only a single instance of the common independent variable data and retrieve the common independent variable data based on an independent variable data handle or pointer for use with multiple dependent variable data. For example, during submarine simulations, an independent variable such as depth may be common to multiple types of collected dependent variable instrumentation data such as temperature, pressure, etc.

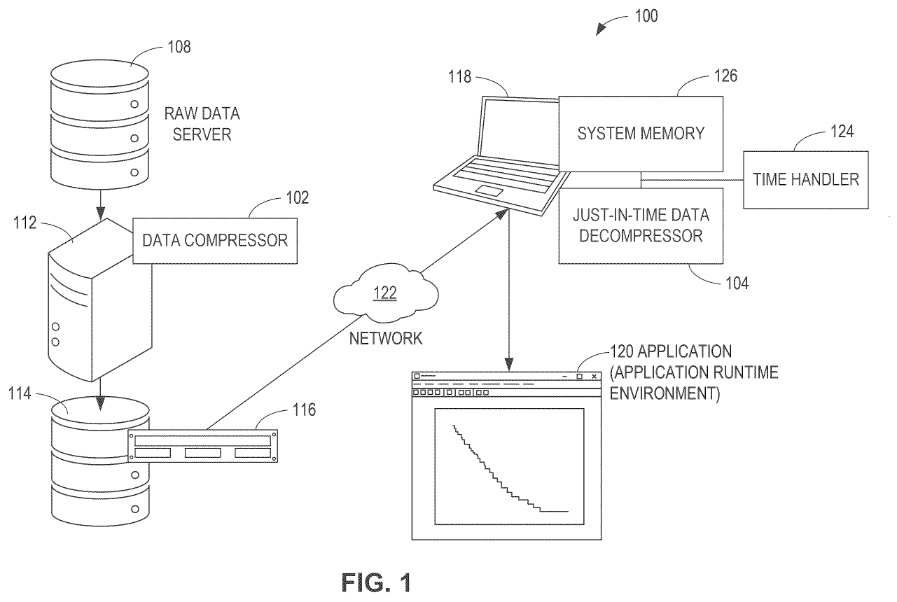

FIG. 1 is an example environment 100 in which an example data compressor 102 operates to compress data and an example just-in-time (JIT) data decompressor 104 operates to decompress data in accordance with examples disclosed herein. The environment includes an example raw data server 108, an example compression computer 112, example storage 114, an example server 116, an example client computer 118, and an example application 120. In the illustrated example of FIG. 1, the client computer 118 is in communication with the server 116 via an example network 122 which may be a private network or a public wide area network (WAN) such as the Internet. In such examples, the raw data server 108, the compression computer 112, the storage 114, and the server 116 are hosted on resources in a data center. In some examples, the network 122 is a cloud computing network and the raw data server 108, the compression computer 112, the storage 114, and the server 116 are hosted on cloud resources. In the example of FIG. 1, the client computer 118 includes an example time handler 124 and example system memory 126 that is accessible by the JIT data decompressor 104 and by the time handler 124.

In the illustrated example of FIG. 1, the raw data server 108 stores uncompressed data (e.g., in ASCII text format in ASCII text files). For example, when used to record signal data and corresponding time data collected during a flight session (e.g., a flight simulation session or an actual flight session), the raw data server 108 stores the recorded signal data and the time data as uncompressed data. In the illustrated example of FIG. 1, the compression computer 112 is provided with the data compressor 102. The compression computer 112 accesses and loads uncompressed data from the raw data server 108 and to local memory. The data compressor 102 compresses the uncompressed data using examples disclosed herein.

In some examples, the compression computer 112 stores related compressed data using an object-of-objects arrangement in a single file. For example, during a flight session (e.g., a flight simulation session or an actual flight session), multiple sets of aircraft instrumentation data may be recorded for corresponding instrumentation signals (e.g., an airspeed waveform signal, an altitude waveform signal, a pitch attitude waveform signal, a roll attitude waveform signal, a yaw attitude waveform signal, an air temperature waveform signal, etc.) as aircraft flight data. In some examples, a file storing raw, uncompressed instrumentation data includes a header that identifies the type of instrumentation data in that file and the type of time data (e.g., sample rate) for that instrumentation data. During the flight session, different instruments may be sampled at different sample rates to generate corresponding instrumentation signal data at different sampling frequencies. For example, an altitude instrumentation signal may be sampled from an altimeter instrument at a sample rate of 100 Hertz (Hz) and an airspeed instrumentation signal may be sampled from an air data sensor instrument at a sample rate of 500 Hz. Because the different instrumentation data are related to the same flight session, the data compressor 102 compresses the different instrumentation data as part of a single file that stores the resulting compressed data. In other examples, the multiple files are used to store multiple groupings of related compressed data. For example, one file may store two types of compressed instrumentation data (e.g., airspeed and altitude data) and another file may store two or more other types of instrumentation data (e.g., pitch attitude, roll attitude, and yaw attitude data). Example file formats that may be used to store the compressed data include text files and binary files (e.g., a Hierarchical Data Format, version 5, (HDF5) file, etc.).

The storage 114 is provided to store compressed data generated by the data compressor 102. For example, after the data compressor 102 generates the compressed data, the compression computer 112 transfers the compressed data to the storage 114. The server 116 is provided to serve files that include the compressed data from the storage 114 to the client computer 118 and/or any other client computers via the network 122. In this manner, the storage 114 and the server 116 operate as a central source of information that is accessible by users or processes via distributed client computers connected to the server 116 through the network 122.

When the client computer 118 retrieves a file of compressed data from the storage 114, the client computer 118 loads the compressed data file into the system memory 126. For example, the client computer 118 can retrieve a file from the storage 114 in response to a request from a user or process running on the client computer 118. In response to a subsequent request (e.g., from the user or process) to access a portion of the compressed data loaded into the system memory 126, the just-in-time data decompressor 104 decompresses the requested portion of the compressed data into a different area of the system memory 126 for subsequent use of the uncompressed data. In addition, the time handler 124 retrieves a time vector from the compressed data file in the system memory 126. The time vector includes time values that align with the uncompressed data.

The application 120 is executed by the client computer 118 in an application runtime environment. The application 120 can run analysis tools and generate engineering results based on decompressed data in the system memory 126. In examples disclosed herein, during runtime of the application 120, the application 120 generates requests to access files from the storage 114 and to decompress portions of compressed data in the system memory 126. The requests may be based on inputs from users interacting with a user interface of the application 120 and/or may be from a process (e.g., a signal plotting process, a filtering process, a modeling process, a statistical analyses process, a mathematical process, etc.) of the application 120 executing during the runtime of the application 120.

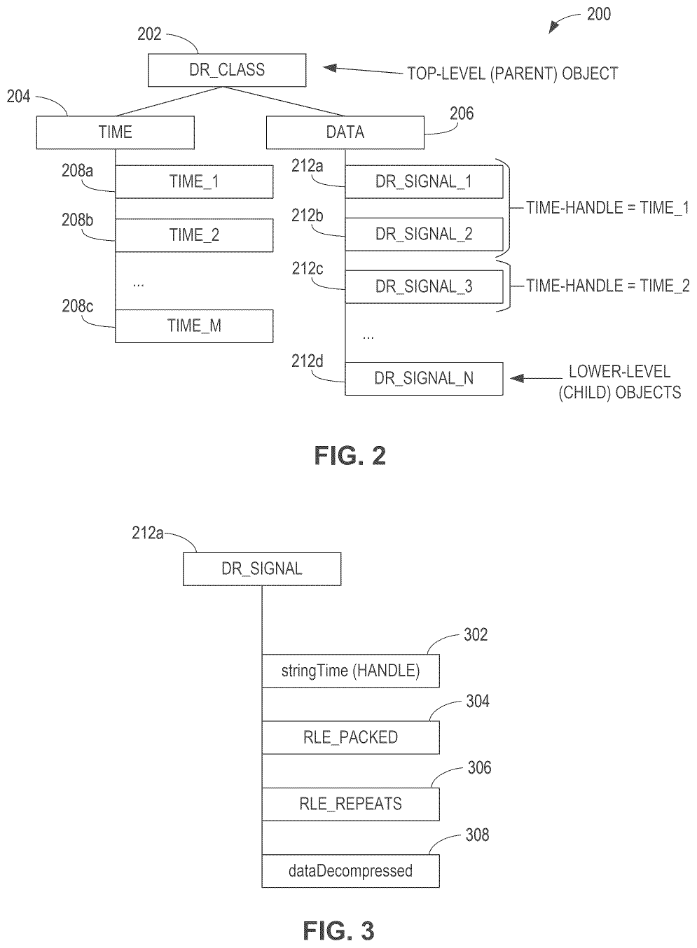

FIG. 2 is an example object-of-objects data storage framework 200 to store multiple child objects in a parent object in object-oriented programming. The object-of-objects data storage framework 200 includes an example parent data record (DR) object 202 (e.g., a top-level object) that is instantiated based on a parent data record class (DR_CLASS). In examples disclosed herein, the parent DR object 202 is also referred to as an object-of objects parent object or an object-of-objects structure. The parent data record class (DR_CLASS) corresponding to the parent DR object 202 includes a time property 204 and defines and includes a signal data child class that implements an example signal data array 206 of signal data objects (e.g., the signal data child objects 212a-d). For example, the signal data array 206 may be implemented as a structure with fields. In the example of FIG. 2, the time property 204 corresponds to independent variable data shown as time and the signal data array 206 is dependent variable data shown as signal data. In the example of FIG. 2, a plurality of time vectors 208a-c (e.g., labeled or named Time_1 through Time_M) are included in the time property 204 as uncompressed values, and a plurality of signal data child objects 212a-d (e.g., labeled or named DR_SIGNAL_1 through DR_SIGNAL_N) are instantiations of the signal data child class corresponding to the signal data array 206. In the example of FIG. 2, a quantity of time vectors (M) is greater than or equal to one (e.g., M≥1), a quantity of signal data child objects (N) is greater than or equal to one (e.g., N≥1), and the quantity of time vectors (M) is less than or equal to the quantity of signal data child objects (N) (e.g., M≤N).

In flight simulation systems and flight recorders, each of the time vectors 208a-c stores a corresponding listing of time values and each of the signal data child objects 212a-d stores a corresponding listing of instrumentation data collected during a flight session (e.g., a flight simulation session or an actual flight session) as aircraft flight data. Examples of such instrumentation signals include an airspeed waveform signal, an altitude waveform signal, a pitch attitude waveform signal, a roll attitude waveform signal, a yaw attitude waveform signal, an air temperature waveform signal, etc. In examples disclosed herein, “listing of time values,” “time values,” and “time data” are used interchangeably to refer to a sequence of time values corresponding to recorded or collected data values of instrumentation data.

In the example of FIG. 2, first and second signal data child objects 212a, b are assigned a first time handle of “Time_1”. As such, the first time handle, “Time_1”, associates both of the first and second signal data child objects 212a,b to a first time vector 208a. In examples disclosed herein, when two instrumentation data sets (e.g., instrumentation data values in the first and second signal data child objects 212a,b) are associated with the same listing of time values, the two instrumentation data sets were recorded at the same sample rate and same starting time. As such, the instrumentation values of the two instrumentation data sets overlap one another in time along the same time vector of time values (e.g., time values in the first time vector 208a). For example, a first data value of the first instrumentation data set and a first data value of the second instrumentation data set align with the same first time value. In addition, a second data value of the first instrumentation data set and a second data value of the second instrumentation data set align with the same second time value, and so on.

Also in the example of FIG. 2, a third signal data child object 212c is assigned a second time handle of “Time_2”. As such, the second time handle, “Time_2”, associates the single third signal data child object 212c to a second time vector 208b. Accordingly, in examples disclosed herein, the object-of-objects data storage framework 200 can be used to assign a single independent variable child object (e.g., the first time vector 208a) to multiple dependent variable child objects (e.g., the first and second signal data child objects 212a,b) and/or assign a single independent variable child object (e.g., the second time vector 208b) to a single dependent variable child object (e.g., the third signal data child object 212c).

FIG. 3 is the first signal data child object 212a of the object-of-objects data storage framework 200 of FIG. 2 in which the data compressor 102 of FIG. 1 stores compressed data. In examples disclosed herein, the data compressor 102 compresses data using a run-length encoding (RLE) compression algorithm. However, examples disclosed herein may be implemented using any other data compression algorithm.

In the example of FIG. 3, the first signal data child object 212a includes a plurality of properties that include an example time handle property 302 (stringTime), an example RLE packed values array 304, an example RLE repetition values array 306, and an example decompressed data array 308 (dataDecompressed). The time handle property 302 is of data type string and stores a time handle or pointer that references a listing of time values (e.g., a time vector of uncompressed time values) corresponding to instrumentation data of the first signal data child object 212a. For example, the time handle property 302 can store a time handle of “Time_1” (FIG. 2).

The first signal data child object 212a stores compressed data using the RLE packed values array 304 and the RLE repetition values array 306. For example, during a compression process to compress instrumentation data, the data compressor 102 may use a RLE compression algorithm to generate a first data array including packed instrumentation data values and store the first data array of packed instrumentation data values in the RLE packed values array 304. In addition, the data compressor 102 generates a second data array including run-length repetition values and stores the run-length repetition values data array in the RLE repetition values array 306.

A run-length repetition value in the RLE repetition values array 306 represents a number of times that a corresponding packed value in the RLE packed values array 304 occurs seriatim in uncompressed instrumentation data values. For example, for compressed data represented by an array of [2,1,3] in the RLE packed values array 304 and an array of [3,5,1] in the RLE repetition values array 306, corresponding decompressed data is [222111113]. In this example, the RLE packed values array 304 has three array index positions arranged as [index 0, index 1, index 2] and the RLE repetition values array 306 also has the same array index positions. Each array index position of the RLE packed values array 304 corresponds to (or aligns with) the same array index position of the RLE repetition values array 306.

As such, the value ‘3’ at array index position 0 (zero) of the RLE repetition values array 306 indicates that the decompressed data includes three consecutive instances of the value ‘2’ which is at the same array index position 0 (zero) of the RLE packed values array 304. Similarly, the value ‘5’ at array index position 1 of the RLE repetition values array 306 indicates that the decompressed data includes five consecutive instances of the value ‘1’ which is at the same array index position 1 of the RLE packed values array 304, and the value ‘1’ at array index position 2 of the RLE repetition values array 306 indicates that the decompressed data includes one instance of the value ‘3’ which is at the same array index position 2 of the RLE packed values array 304.

The first signal data child object 212a includes the decompressed data array 308 which is empty prior to decompression. For example, when the JIT data decompressor 104 runs a decompression process on a portion of the compressed data in the first signal data child object 212a in response to a data access request from the application 120 (FIG. 1) during application runtime, the JIT data decompressor 104 writes the decompressed data to the decompressed data array 308. The application 120 can then access the decompressed data by referencing the decompressed data array 308. When the application 120 no longer needs access to the decompressed data, the decompressed data array 308 can be marked to expunge or overwrite the decompressed data and a memory allocated for the decompressed data array 308 can be freed in the system memory 126. As such, the compressed form of that data is still stored in the first signal data child object 212a for subsequent decompression and access while efficiently using capacity of the system memory 126 by releasing allocated memory when not in use and re-allocating the memory when a data access request is received from the application 120.

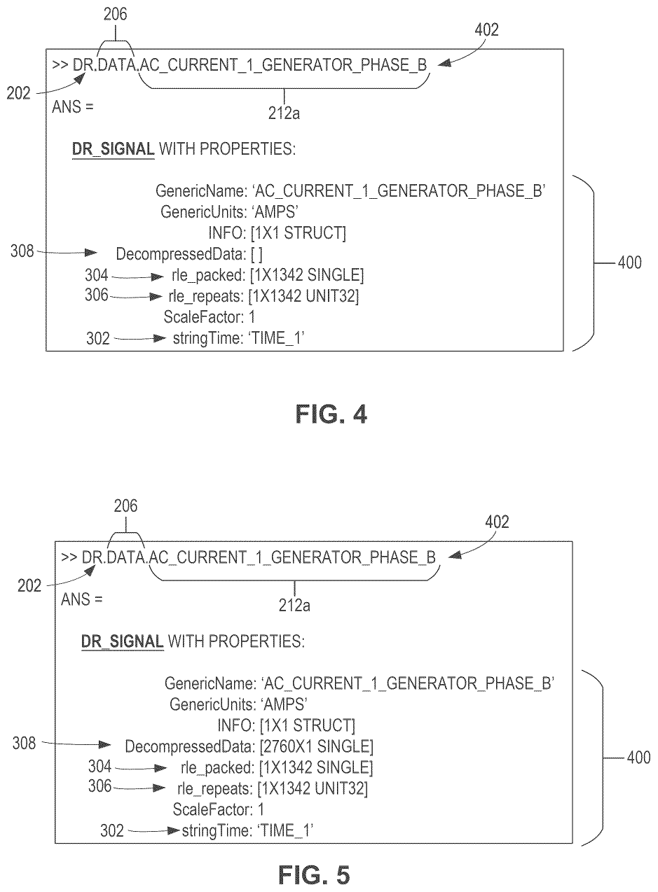

FIG. 4 shows an example properties listing 400 of the signal data child object 212a (FIG. 3) before data decompression. FIG. 5 shows the properties listing 400 of the signal data child object 212a after data decompression. The example code of FIGS. 4 and 5 and other code to implement examples disclosed herein may be implemented using any suitable programming language that supports an object-oriented framework. An example of such a programming language is the MATLAB® programming language, which is developed and provided by Math Works, Inc. of Natick, Massachusetts, United States of America. The examples of FIGS. 4 and 5 include an example child object access expression 402 shown as “DR.DATA.AC_CURRENT_1_GENERATOR_PHASE_B”. The child object access expression 402 may be in a data access request from the application 120 (FIG. 1). For example, the application 120 may call a .Data() method using the expression “DR.DATA.AC_CURRENT_1_GENERATOR PHASE B. Data” to retrieve the contents of a signal data child object (e.g., one of the signal data child objects 212a-d) corresponding to the signal name “AC_CURRENT_1_GENERATOR_PHASE_B”. In the child object access expression 402, “DR” references the parent DR object 202 (FIG. 2), “DATA” references the signal data array 206 (FIG. 2), and “AC_CURRENT_1_GENERATOR_PHASE_B” references the signal data child object 212a (FIGS. 2 and 3). In the examples of FIGS. 4 and 5, the instrumentation data includes alternating current (AC) measures of phase B of a generator. However, instrumentation data may represent any other measures.

In some examples, a function method such as a plot method may be called by the application 120 using a plot method expression of “DR.DATA.AC_CURRENT_1_GENERATOR_PHASE_B. plot” to generate a graph of a signal plot. In such plot method expression, “plot” references a plot method to generate the signal plot representative of instrumentation data in the signal data child object 212a referenced by “AC_CURRENT_1_GENERATOR_PHASE_B”.

The properties 302, 304, 306, 308 of the signal data child object 212a described above in connection with FIG. 3 are also shown in the properties listing 400 of FIGS. 4 and 5. The time handle property 302 in the example of FIG. 4 is set to the handle name ‘Time_1’ which corresponds to a listing of time values (e.g., a time vector of uncompressed time values) in the time vector 208a of FIG. 2. In some examples, if the parent DR object 202 includes only a single listing of time values that applies to all of the instrumentation data sets in the data child objects 212a-d, the time handle property 302 may be left empty. As such, an empty time handle property 302 indicates that there is only one listing of time values for the parent DR object 202. In the example of FIG. 4, a 1×1342 data array of data type ‘single’ is allocated in memory for the RLE packed values array 304, a 1×1342 data array of data type 32-bit unsigned integer (unit32) is allocated in memory for the RLE repetition values array 306, and an empty array is allocated for the decompressed data array 308.

In the example of FIG. 4, the RLE packed values array 304 and the RLE repetition values array 306 store compressed instrumentation data, as described above in connection with FIG. 3, and the array for the decompressed data array 308 is empty because the compressed instrumentation data has not yet been decompressed. However, in response to a data access request (e.g., a “DR.DATA.AC_CURRENT_1_GENERATOR_PHASE_B. Data” method) for instrumentation data in the signal data child object 212a, data decompression is performed just-in-time to generate the requested uncompressed instrumentation data without decompressing other instrumentation data (e.g., instrumentation data of signal data child objects 212b-d) in the same object-of-objects parent object (e.g., the parent DR object 202 of FIG. 2) in which the signal data child object 212a is located. For example, the JIT data decompressor 104 (FIG. 1) decompresses the compressed data in the RLE packed values array 304 and the RLE repetition values array 306 using an RLE decompression algorithm (or any other suitable algorithm (e.g., a lossless decompression algorithm)) and generates corresponding decompressed data.

To store the uncompressed instrumentation data, the example properties listing 400 in FIG. 5 includes a 2760×1 data array of data type ‘single’ allocated in memory for the decompressed data array 308. To store the uncompressed data, the client computer 118 allocates capacity in the system memory 126 to the decompressed data array 308 so that the JIT data decompressor 104 can store the uncompressed data in the decompressed data array 308. In some examples, the decompressed data array 308 is a dynamic array such that the client computer 118 can increase the allocated capacity to the decompressed data array 308 over time during the decompression process performed by the JIT data decompressor 104. In the illustrated example of FIG. 4, the decompressed data size (or uncompressed data size) of the decompressed instrumentation data is 11,040 bytes based on the decompressed data array 308 storing 2,760 ‘single’ data type values and based on a ‘single’ data type value holding a signed 32-bit (4-byte) single-precision floating-point value (e.g., 2,760 ‘single’ values×4 bytes=11,040 bytes). The compressed data size of the instrumentation data is 10,736 bytes based on the RLE packed values array 304 storing 1,342 ‘single’ data type values, the RLE repetition values array 306 storing another 1,342 ‘single’ data type values, and each ‘single’ data type value and ‘unit32’ data type value represented by 4 bytes (e.g., (1,342×4 bytes)+(1,342×4 bytes)=10,736).

Based on the data access request, the decompression is performed just-in-time and stored in the system memory 126. The uncompressed data can be subsequently discarded in response to the uncompressed data no longer being needed. As such, memory space of the system memory 126 can be efficiently used through dynamic allocation upon the data access method being called and through memory release when the corresponding decompressed data is no longer needed. In other examples, any other process (e.g., a signal plotting process, a filtering process, a modeling process, a statistical analyses process, a mathematical process, etc.) may be called, which itself invokes the data access method, to cause JIT decompression of instrumentation data.

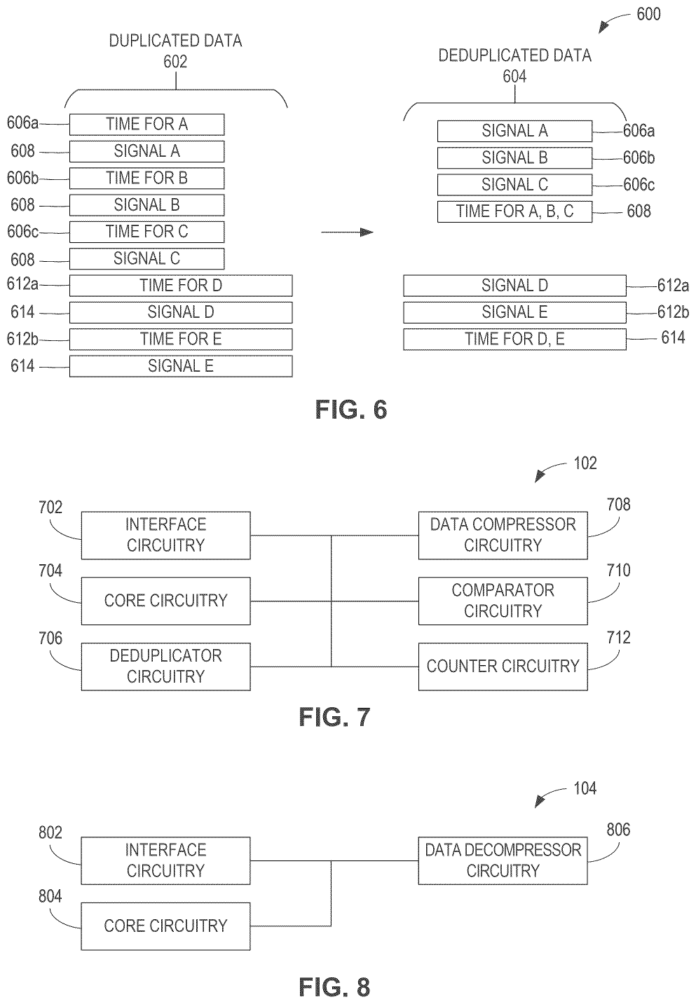

FIG. 6 is an example signal-to-time map 600 showing example duplicated data 602 and example deduplicated data 604. Each of the duplicated data 602 and the deduplicated data 604 includes multiple example signal data child objects 606a-c. In the duplicated data 602, each of the signal data child objects 606a-c is stored in association with a separate instance of the same listing of time values 608 (e.g., the same time vector). During data deduplication, the data compressor 102 (FIG. 1) deduplicates the multiple instances of the listing of time values 608 into a single instance and associates the single instance of the listing of time values 608 with all of the signal data child objects 606a-c. For example, as described above in connection with FIGS. 2 and 3, the listing of time values 608 is labeled with a time handle or pointer (e.g., handle ‘Time_1’) and each of the signal data child objects 606a-c is assigned that time handle or pointer as described above in connection with FIGS. 3 and 4. As such, deduplicating the listings of time values 608 decreases the data size of the deduplicated data by representing multiple instances of the same listings of time values 608 using only a single instance.

Mapping three signals of instrumentation data (e.g., the signal data child objects 606a-c) to a single listing of time values (e.g., the listings of time values 608) is merely an example. In other examples, fewer or more signals of instrumentation data can be mapped to a single listing of time values. For example, as also shown in the example of FIG. 6, two signal data child objects 612a,b are stored in association with separate instances of the same listing of time values 614 in the duplicated data 602. However, after deduplication, a single instance of the listing of time values 614 is associated with both of the signal data child objects 612a,b in the deduplicated data 604.

FIG. 7 is a block diagram of an example implementation of the data compressor 102 of FIG. 1 to compress instrumentation data into the object-of-objects data storage framework 200 (FIG. 2). The data compressor 102 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the data compressor 102 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

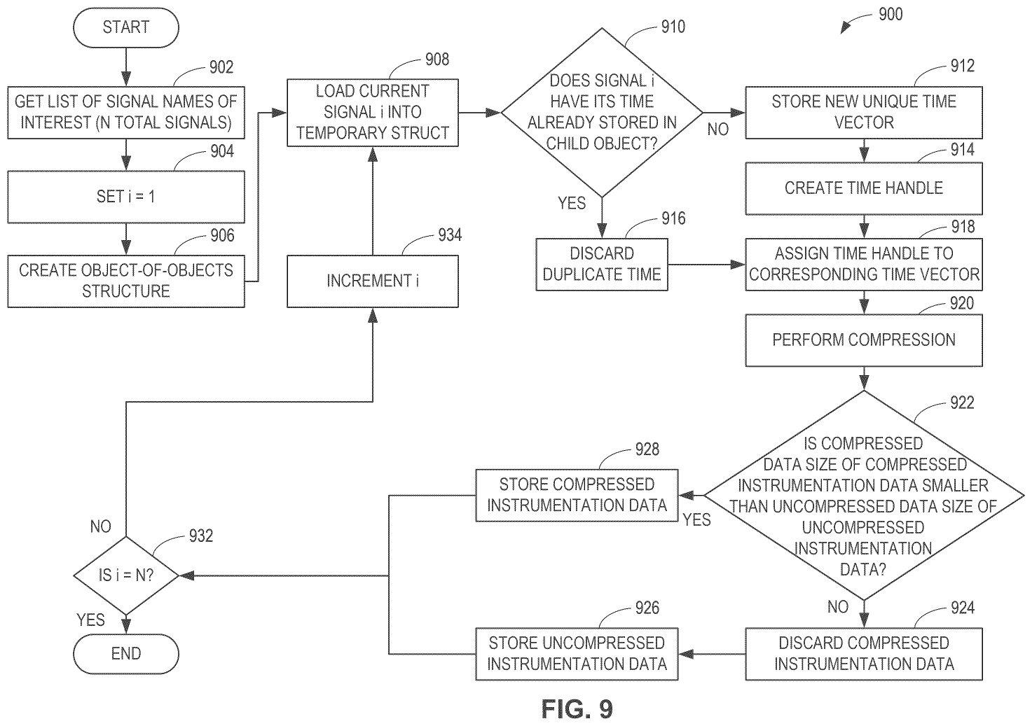

In the example of FIG. 7, the data compressor 102 includes example interface circuitry 702, example core circuitry 704, example deduplicator circuitry 706, example data compressor circuitry 708, example comparator circuitry 710, and example counter circuitry 712. The interface circuitry 702 is provided to access uncompressed instrumentation data from the raw data server 108 and to send data to the storage 114. The core circuitry 704 executes machine-readable instructions, and creates and configures object-of-objects parent objects in accordance with the object-of-objects data storage framework 200 of FIG. 2. The deduplicator circuitry 706 is provided to deduplicate independent variable data, such as time data, from instrumentation data. In some examples, the deduplicator circuitry 706 is instantiated by programmable circuitry executing deduplicator instructions and/or configured to perform operations such as those represented by the flowchart of FIG. 9.

The data compressor circuitry 708 is provided to compress instrumentation data. The data compressor circuitry 708 may use a RLE compression algorithm, as described above in connection with FIG. 3, or use any other suitable compression algorithm (e.g., a lossless compression algorithm) to implement examples disclosed herein. In some examples, the data compressor circuitry 708 is instantiated by programmable circuitry executing data compressor instructions and/or configured to perform operations such as those represented by the flowchart of FIG. 9.

The comparator circuitry 710 is provided to compare data sizes between uncompressed instrumentation data and corresponding compressed instrumentation data to determine whether to store the uncompressed data or the corresponding compressed data in a signal data child object (e.g., the signal data child objects 212a-d of FIG. 2). For example, if the comparator circuitry 710 determines that the data size of compressed instrumentation data generated by the data compressor circuitry 708 is greater than or equal to its corresponding uncompressed instrumentation data, the compressed data is discarded and the uncompressed data is stored in the signal data child object because the uncompressed data uses less memory space than the compressed data. In some examples, the comparator circuitry 710 is instantiated by programmable circuitry executing comparator instructions and/or configured to perform operations such as those represented by the flowchart of FIG. 9.

The counter circuitry 712 is provided to track a count of how many uncompressed instrumentation signal data sets have been compressed by the data compressor 102 during a data compression session. For example, the counter circuitry 712 may be incremented each time an uncompressed instrumentation signal data set has been compressed, and the comparator circuitry 710 may compare a count value of the counter circuitry 712 to a total quantity of uncompressed instrumentation signal data sets to determine when the data compressor 102 has finished compressing the available uncompressed instrumentation signal data sets. In some examples, the counter circuitry 712 is instantiated by programmable circuitry executing counter instructions and/or configured to perform operations such as those represented by the flowchart of FIG. 9.

As described above, the interface circuitry 702, the core circuitry 704, the deduplicator circuitry 706, the data compressor circuitry 708, the comparator circuitry 710, and the counter circuitry 712 of FIG. 7 are structures. Such structures may implement means for performing corresponding disclosed functions. Examples of such functions are described above in connection with corresponding ones of the interface circuitry 702, the core circuitry 704, the deduplicator circuitry 706, the data compressor circuitry 708, the comparator circuitry 710, and the counter circuitry 712 and are described below in connection with the flowchart of FIG. 9.

FIG. 8 is a block diagram of an example implementation of the JIT data decompressor 104 of FIG. 1 to perform selective JIT decompression of instrumentation data in one or more of the signal data child objects 212a-d (FIG. 2) without decompressing the compressed data of all the signal data child objects 212a-d. The JIT data decompressor 104 of FIG. 8 may be instantiated (e.g., creating an instance of, bring into being for any length of time, materialize, implement, etc.) by programmable circuitry such as a Central Processor Unit (CPU) executing first instructions. Additionally or alternatively, the JIT data decompressor 104 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

The JIT data decompressor 104 includes example interface circuitry 802, example core circuitry 804, and example data decompressor circuitry 806. The interface circuitry 802 is provided to communicate with the server 116 (FIG. 1) to access instrumentation data stored as compressed or uncompressed data and object-of-objects parent objects. The core circuitry 804 is provided to execute machine-readable instructions (e.g., execute the application 120 of FIG. 1).

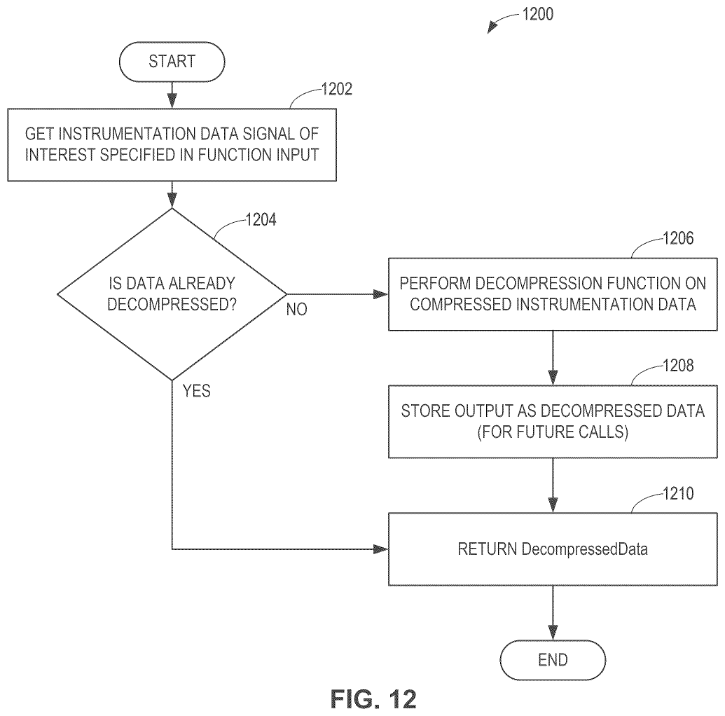

The data decompressor circuitry 806 is provided to decompress compressed instrumentation data. The data decompressor circuitry 806 may use a RLE decompression algorithm or use any other suitable compression algorithm (e.g., a lossless decompression algorithm) to implement examples disclosed herein. In some examples, the data decompressor circuitry 806 is instantiated by programmable circuitry executing data decompressor instructions and/or configured to perform operations such as those represented by the flowchart of FIG. 12.

As described above, the interface circuitry 802, the core circuitry 804, and the data decompressor circuitry 806 of FIG. 8 are structures. Such structures may implement means for performing corresponding disclosed functions. Examples of such functions are described above in connection with corresponding ones of the interface circuitry 802, the core circuitry 804, and the data decompressor circuitry 806 and are described below in connection with the flowcharts of FIGS. 9-12.

While an example manner of implementing the data compressor 102 of FIG. 1 is illustrated in FIG. 7 and the JIT data decompressor 104 of FIG. 1 is illustrated in FIG. 8, one or more of the elements, processes, and/or devices illustrated in FIGS. 7 and 8 may be combined, divided, re-arranged, omitted, eliminated, and/or implemented in any other way. Further, the interface circuitry 702, the core circuitry 704, the deduplicator circuitry 706, the data compressor circuitry 708, the comparator circuitry 710, the counter circuitry 712, and/or, more generally, the data compressor 102 of FIG. 7; the interface circuitry 802, the core circuitry 804, the data decompressor circuitry 806 and/or, more generally the JIT data decompressor 104 of FIG. 8; and the time handler 124 of FIG. 1 may be implemented by hardware alone or by hardware in combination with software and/or firmware. Thus, for example, any of the interface circuitry 702, the core circuitry 704, the deduplicator circuitry 706, the data compressor circuitry 708, the comparator circuitry 710, the counter circuitry 712, and/or, more generally, the data compressor 102; the interface circuitry 802, the core circuitry 804, the data decompressor circuitry 806 and/or, more generally the JIT data decompressor 104; and the time handler 124 of FIG. 1, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data compressor 102 of FIG. 7, the JIT data decompressor 104 of FIG. 8, and/or the time handler 124 of FIG. 1 may include one or more elements, processes, and/or devices in addition to, or instead of, those illustrated in FIGS. 7 and 8, and/or may include more than one of any or all of the illustrated elements, processes and devices.

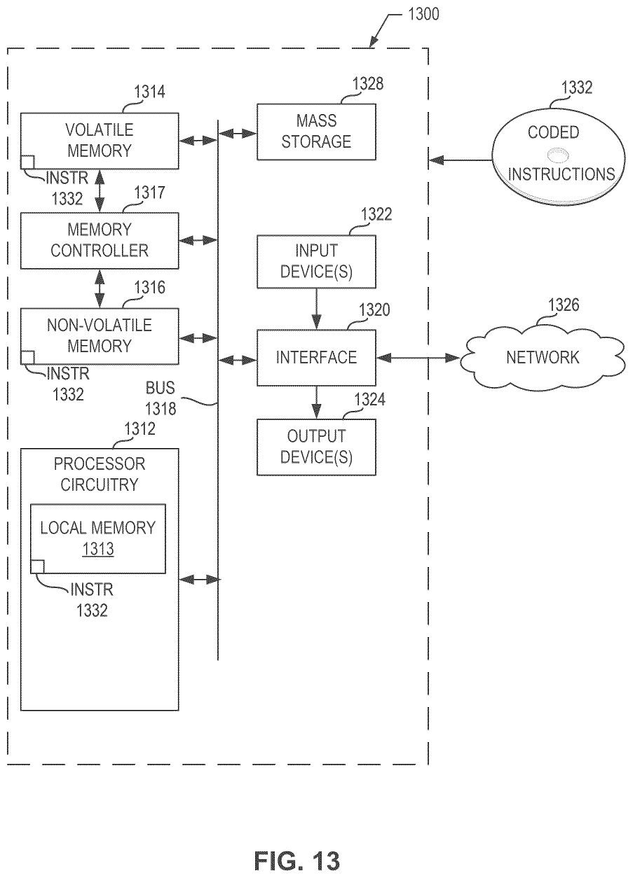

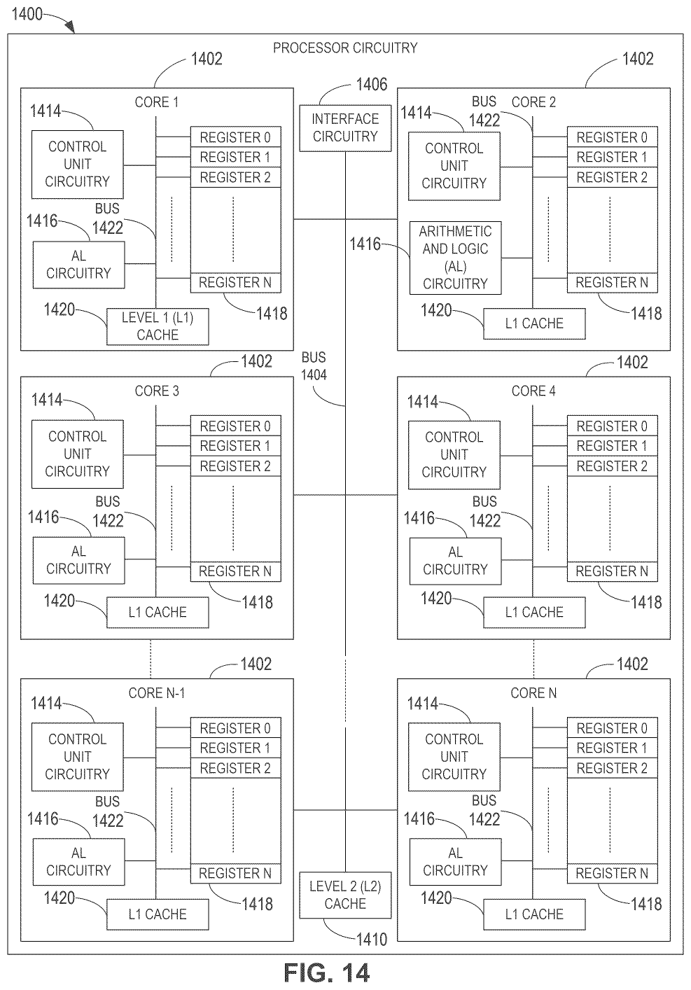

Flowcharts representative of example machine-readable instructions, which may be executed by programmable circuitry to implement and/or instantiate the data compressor 102 of FIG. 7, the JIT data decompressor 104 of FIG. 8, and/or the time handler 124 of FIG. 1 and/or representative of example operations which may be performed by programmable circuitry to implement and/or instantiate the data compressor 102 of FIG. 7, the JIT data decompressor 104 of FIG. 8, and/or the time handler 124 of FIG. 1, are shown in FIGS. 9-12. The machine-readable instructions may be one or more executable programs or portion(s) of one or more executable programs for execution by programmable circuitry such as the programmable circuitry 1312 shown in the example programmable circuitry platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The programs may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entirety of the programs and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example programs are described with reference to the flowcharts illustrated in FIGS. 9-12, many other methods of implementing the example data compressor 102 of FIG. 7, the JIT data decompressor 104 of FIG. 8, and the time handler 124 of FIG. 1 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form one or more programs such as programs disclosed herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding programs can be executed in whole or in part. Thus, machine-readable, computer-readable and/or machine-readable media, as used herein, may include instructions and/or programs regardless of the particular format or state of the machine-readable instructions and/or programs.

The machine-readable instructions described herein can be represented by any past, present, or future instruction language, scripting language, programming language, etc. For example, the machine-readable instructions may be represented using any of the following languages: C, C++, Java, C#, Perl, Python, MATLAB, JavaScript, HyperText Markup Language (HTML), Structured Query Language (SQL), Swift, etc.

As mentioned above, the example operations of FIGS. 9-12 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement the data compressor 102 (FIGS. 1 and 7) to compress instrumentation data. The example machine-readable instructions and/or the example operations 900 of FIG. 9 begin at block 902, at which the interface circuitry 702 (FIG. 7) accesses a list of signal names of interest. For example, the interface circuitry 702 accesses the raw data server 108 (FIG. 1) to obtain a list of instrumentation signals for which uncompressed instrumentation signal data is stored in the raw data server 108. In some examples, uncompressed instrumentation signal data for a plurality of ‘N’ instrumentation signals is stored in a single file in the raw data server 108. In other examples, the plurality of ‘N’ instrumentation signals are stored across two or more files. At block 904, the core circuitry 704 (FIG. 7) sets a count value (i) of the counter circuitry 712 equal to one (e.g., i=1). For example, the core circuitry 704 resets the counter circuitry 712 to a value of one.

At block 906, the core circuitry 704 creates an object-of-objects structure. For example, the core circuitry 704 creates the object-of-objects structure in accordance with the object-of-objects data storage framework 200 of FIG. 2 above.

At block 908, the core circuitry 704 loads a current uncompressed instrumentation signal data set (i) into a temporary data structure. At block 910, the core circuitry 704 determines whether the current uncompressed instrumentation signal data set (i) already has its corresponding time values stored in a time vector (e.g., one of the time vectors 208a-c of FIG. 2). For example, the time values of the current uncompressed instrumentation signal data set (i) may be the same as a previous uncompressed instrumentation signal data set processed through block 910 and stored in the time vector. Alternatively, the time values of the current uncompressed instrumentation signal data set (i) may be different or unique relative to previous uncompressed instrumentation signal data sets of the plurality of ‘N’ instrumentation signals processed through block 910. As such, the time values have not been stored in a time vector. If the core circuitry 704 determines that the current signal (i) does not have its corresponding time values stored in a time vector (block 910: NO), control advances to block 912 at which the core circuitry 704 stores the time values of the current uncompressed instrumentation signal data set (i) as a new time vector. For example, the core circuitry 704 stores the time data in one of the time vectors 208a-c as uncompressed time values. In examples disclosed herein, since time increases monotonically (e.g., time uniquely increases such that each time value is unique relative to other time values in a time vector), the time data remains uncompressed in the parent DR object 202 (FIG. 2). For example, the time data is not compressed when the instrumentation data is compressed (e.g., block 920) and stored (e.g., block 928) in the signal data child objects 212a-d (FIG. 2) of the parent DR object 202.

At block 914, the deduplicator circuitry 706 (FIG. 7) creates a time handle. For example, the time handle (e.g., the time handle property 302 of FIG. 3) references (e.g., is a pointer to) the time values of the current time vector. Over multiple iterations of the instructions and/or operations 900, the core circuitry 704 may create multiple time handles when time data differs across multiple uncompressed instrumentation signal data sets. For example, first time data of a first uncompressed instrumentation signal data set may be different from second time data of a second uncompressed instrumentation signal data set. In such an example, during one iteration of block 914, the core circuitry 704 creates a first time handle to reference a corresponding time vector stored at block 912 in a first one of the time vectors 208a-c. During a second iteration of the same example, the core circuitry 704 creates a second time handle at block 914 to reference its corresponding time vector stored at block 912 in a second one of the time vectors 208a-c because the second time data is different or unique relative to the first time data. By using the first and second time handles for the different ones of the first and second time data, the first and second time handles can be used to align the first and second time data with corresponding ones of the first and second uncompressed instrumentation signal data sets.

If the core circuitry 704 determines that the current signal (i) does have its corresponding time values stored in a time vector (block 910: YES), the deduplicator circuitry 706 discards the duplicate time values of the current signal (i) (block 916). Over multiple iterations of the instructions and/or operations 900, the deduplicator circuitry 706 stores some time vectors at block 912 when they do not match previously encountered time vectors from other uncompressed instrumentation signal data sets of the plurality of ‘N’ instrumentation signals accessed at block 902 and discards other time vectors at block 916 that do match previously encountered time vectors. For example, for first uncompressed instrumentation signal data having a unique first time vector not previously encountered for the plurality of ‘N’ instrumentation signals, the deduplicator circuitry 706 stores some time vectors at block 912 and for uncompressed instrumentation signal data having a second time vector matching the first time vector of the first uncompressed instrumentation signal data, the deduplicator circuitry 706 discards the second time vector at block 916 because the first time vector stored at block 912 can be used with both the first and second uncompressed instrumentation signal data.

After block 914 or after block 916, the deduplicator circuitry 706 assigns the time handle property (e.g., the time handle property 302 of FIGS. 4 and 5) of the DR_SIGNAL child object (e.g., the signal data child object 212a of FIGS. 2 and 3) to the corresponding time vector in the TIME array (e.g., the time property 204 of FIG. 2) of the DR_CLASS (e.g., the parent DR object 202 of FIG. 2) (block 918). An example time handle is ‘Time_1’ stored in the time handle property 302. For example, the deduplicator circuitry 706 assigns a time handle recently created at block 914 during a current iteration of the instructions and/or operations 900 if the current time data was unique relative to previously processed time data of a set of ‘N’ signals. Alternatively, the deduplicator circuitry 706 assigns a time handle previously created at block 914 during a previous iteration of the instructions and/or operations 900 if the current time data of a current uncompressed instrumentation signal data set is the same as a previously processed time data of the set of ‘N’ signals.

At block 920, the data compressor circuitry 708 performs compression on uncompressed instrumentation signal data. For example, the data compressor circuitry 708 may use the RLE compression algorithm described above in connection with FIG. 3 (or any other suitable compression algorithm (e.g., a lossless compression algorithm)) to compress uncompressed instrumentation data values to generate compressed instrumentation data. The uncompressed instrumentation data values align with time values of time data that was analyzed at block 910 and was assigned a time handle at block 918.

At block 922, the comparator circuitry 710 determines whether a compressed data size of the compressed instrumentation data generated at block 920 is smaller than an uncompressed data size of the corresponding uncompressed instrumentation data values. In some examples, when the compressed data size of the compressed instrumentation data is larger than the uncompressed data size of the corresponding uncompressed instrumentation data values, the compressed instrumentation data is referred to as resulting from negative compression because instead of decreasing the data size, the compression process increased the data size. If the comparator circuitry 710 determines that the compressed data size of the compressed instrumentation data is not smaller than an uncompressed data size of the corresponding uncompressed instrumentation data values (block 922: NO), control advances to block 924 at which the core circuitry 704 discards the compressed instrumentation data. At block 926, the core circuitry 704 causes storage of the uncompressed instrumentation data. For example, the core circuitry 704 causes storage of the uncompressed instrumentation data in one of the signal data child objects 212a-d of FIG. 2.

Returning to block 922, if the comparator circuitry 710 determines that the compressed data size of the compressed instrumentation data is smaller than an uncompressed data size of the corresponding uncompressed instrumentation data values (block 922: YES), control advances to block 928 at which the core circuitry 704 causes storage of the compressed instrumentation data. For example, the core circuitry 704 causes storage of the compressed instrumentation data in one of the signal data child objects 212a-d of FIG. 2.

In some examples, first uncompressed instrumentation data values from a first one of the ‘N’ signals do not compress to a smaller compressed data size than an uncompressed data size of the first uncompressed instrumentation data values and second uncompressed instrumentation data values from a second one of the ‘N’ signals do compress to a smaller compressed data size than an uncompressed data size of the second uncompressed instrumentation data values. In such examples, the core circuitry 704 discards first compressed data generated at block 920 based on the first uncompressed instrumentation data values, as described above in connection with block 924, and causes storage of the first uncompressed data values (instead of the first compressed data) in a first one of the signal data child objects 212a-d, as described above in connection with block 926. Also, the core circuitry 704 keeps second compressed data generated at block 920 based on the second uncompressed instrumentation data values and stores the second compressed data (instead of the second uncompressed instrumentation data) in a second one of the signal data child objects 212a-d.

In some examples, the first and second uncompressed data values align with the same time values. In such examples, the deduplicator circuitry 706 causes storage of the same time handle of a time vector in a property of the first one of the signal data child objects 212a-d corresponding to the stored first uncompressed instrumentation data values and in a property of the second one of the signal data child objects 212a-d of the stored second compressed data corresponding to the second uncompressed instrumentation data values. In some examples, the time vector, the first uncompressed instrumentation data, and the second compressed data are stored in a single file in the storage 114. Accordingly, at some later time, a client computer (e.g., the client computer 118 of FIG. 1) can concurrently retrieve the time vector, the first uncompressed instrumentation data, and the second compressed data by retrieving one file from the server 116. Alternatively, the time vector, the first uncompressed instrumentation data, and the second compressed data are stored across two or more separate files in the storage 114.

In other examples, the first uncompressed instrumentation data values align with first time values that are different from second time values aligned with the second uncompressed instrumentation data values. In such examples, the deduplicator circuitry 706 causes storage of a first time handle of a first time vector in a property of the first one of the signal data child objects 212a-d corresponding to the stored first uncompressed instrumentation data values and causes storage of a second time handle (different from the first time handle) of a second time vector in a property of the second one of the signal data child objects 212a-d of the stored second compressed data corresponding to the second uncompressed instrumentation data values. The first and second time vectors, the first uncompressed instrumentation data, and the second compressed data may be stored in a single file in the storage 114. Alternatively, the first and second time vectors, the first uncompressed instrumentation data, and the second compressed data are stored across multiple files in the storage 114.

In yet other examples, a first time handle of first time values corresponds to first instrumentation data (e.g., uncompressed or compressed instrumentation data) and to second instrumentation data (e.g., uncompressed or compressed instrumentation data), and a second time handle (different from the first time handle) of second time values corresponds to third instrumentation data (e.g., uncompressed or compressed instrumentation data). In such examples, the first time handle is stored in properties of first and second ones of the signal data child objects 212a-d for the first and second instrumentation data, and the second time handle is stored in a property of a third one of the signal data child objects 212a-d for the third instrumentation data. The first and second time vectors and the first, second, and third instrumentation data may be stored in a single file in the storage 114. Alternatively, first and second time vectors and the first, second, and third instrumentation data are stored across multiple files in the storage 114.

At block 932, the core circuitry 704 determines whether the count value (i) of the counter circuitry 712 is equal to the quantity ‘N’ of instrumentation signals accessed at block 902. If the core circuitry 704 determines that the count value (i) of the counter circuitry 712 is not equal to the quantity ‘N’ of instrumentation signals (block 932: NO), control advances to block 934 at which the core circuitry 704 increments the count value (i) of the counter circuitry 712. Control then returns to block 908 to process a next uncompressed instrumentation signal data set (i) from the plurality of ‘N’ instrumentation signals accessed at block 902. As such, multiple iterations of the instructions and/or operations 900 to process multiple uncompressed instrumentation signal data sets (i) adds each of the uncompressed instrumentation signal data sets (i) as another signal data child object (e.g., the signal data child objects 212a-d of FIG. 2) to a parent object (e.g., the parent DR object 202) in accordance with the object-of-objects data storage framework 200 of FIG. 2. Otherwise, if the core circuitry 704 determines that the count value (i) of the counter circuitry 712 is equal to the quantity ‘N’ of instrumentation signals (block 932: YES), the example instructions and/or operations 900 end.

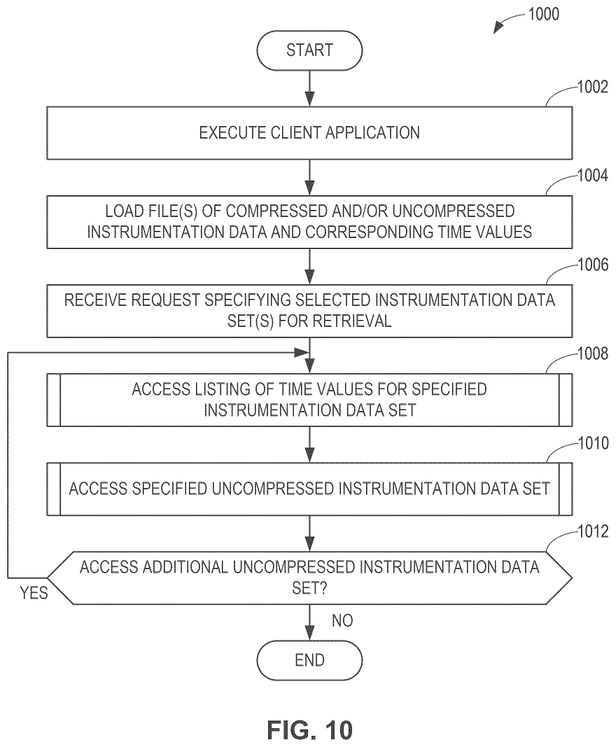

FIG. 10 is a flowchart representative of example machine-readable instructions and/or example operations 1000 that may be executed, instantiated, and/or performed by example programmable circuitry to implement the JIT data decompressor 104 of FIG. 8 to selectively access uncompressed instrumentation data from the object-of-objects storage framework 200 of FIG. 2. The instructions and/or operations 1000 begin at block 1002, at which the client computer 118 (FIG. 1) executes the application 120 (FIG. 1). At block 1004, the interface circuitry 802 (FIG. 8) loads one or more file(s) of compressed and/or uncompressed instrumentation data and corresponding time values into the system memory 126 (FIG. 1). At block 1006, the core circuitry 804 (FIG. 8) receives a request specifying selected instrumentation data set(s) for retrieval. For example, a file loaded into the system memory 126 at block 1004 includes an object-of-objects parent object, such as the parent DR object 202 of FIG. 2, which includes the plurality of signal data child objects 212a-d. The request of block 1006 may be received from the application 120 to execute a data access method (e.g., the data access method of DR.DATA.AC_CURRENT_1_GENERATOR_PHASE_B. Data⇄) based on one or a subset of the instrumentation data sets in the parent DR object 202. As such, the data access method may be used to cause the JIT data decompressor 104 to perform a JIT decompression on only a subset of instrumentation data in the file loaded in the system memory 126 without needing to decompress all of the instrumentation data from the file and store the decompressed data in its entirety in the system memory 126.

At block 1008, the data decompressor circuitry 806 (FIG. 8) accesses a listing of time values for the specified instrumentation data set.

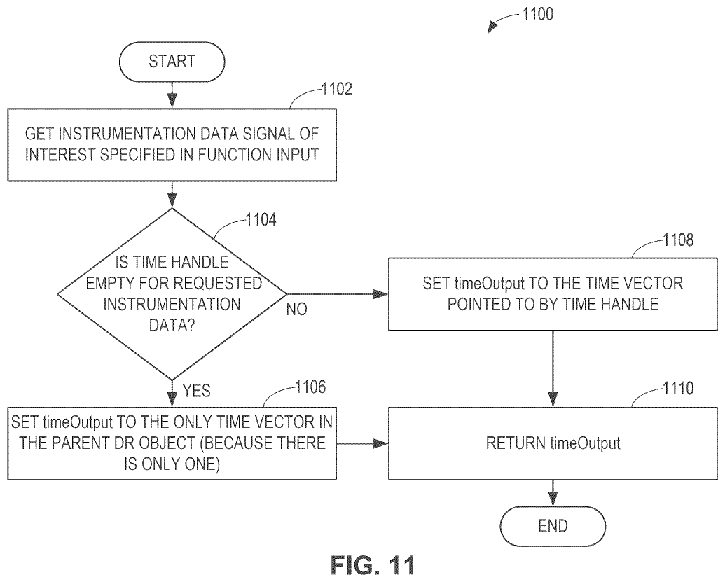

Example instructions and/or operations to implement block 1008 are described below in connection with FIG. 11. At block 1010, the data decompressor circuitry 806 accesses the specified uncompressed instrumentation data set. Example instructions and/or operations to implement block 1010 are described below in connection with FIG. 12.

At block 1012, the core circuitry 804 determines whether to access an additional uncompressed instrumentation data set. For example, if the request received at block 1006 specifies multiple instrumentation data sets (e.g., a plurality of ‘N’ instrumentation signals), the core circuitry 804 determines that at least one additional uncompressed instrumentation data set is to be retrieved. If the core circuitry 804 determines that an additional uncompressed instrumentation data set is to be retrieved (block 1012: YES), control returns to block 1008. Otherwise, the example instructions and/or operations 1000 end. Alternatively, in some examples, block 1012 may be omitted and the instructions and/or operations 1000 end after block 1010. In such examples, the JIT data decompressor 104 can perform another iteration of blocks 1008 and 1010 in response to receiving a subsequent request from a user to access another instrumentation data set.

The example instructions and/or operations 1000 of FIG. 10 may be used to decompress select instrumentation data sets from a file in a JIT manner based on function method requests that operate on the selected data. Function method requests (e.g., a signal plotting method, a filtering method, a modeling method, a statistical analyses method, a mathematical method, etc.) may be called to invoke a data access method (e.g., the “DR.DATA.AC_CURRENT_1_GENERATOR_PHASE_B. Data” method), which causes JIT decompression of instrumentation data. For example, as described above in connection with FIG. 5, a data access method (directly called or indirectly invoked) causes the JIT data decompressor 104 to selectively decompress some of the instrumentation data from a file in the system memory 126. If the request from the application 120 at block 1006 specifies two instrumentation data sets of the parent DR object 202 that correspond to the same listing of time values (e.g., without the request specifying other instrumentation data sets of the parent DR object 202), the interface circuitry 802 accesses the listing of time values from one of the time vectors 208a-c of the parent DR object 202 at block 1008 and accesses the first compressed instrumentation data and the second compressed instrumentation data from corresponding first and second ones of the signal data child objects 212a-d of the parent DR object 202 at block 1010 during a runtime of the application 120.

In addition, the data decompressor circuitry 806 decompresses the first compressed instrumentation data during the runtime to generate first uncompressed instrumentation data to align with the time values and decompresses the second compressed instrumentation data during the runtime to generate second uncompressed instrumentation data to align with the same time values. Based on the request specifying only the two instrumentation data sets of the parent DR object 202, the data decompressor circuitry 806 provides the two uncompressed instrumentation data sets without decompressing other instrumentation data (e.g., third compressed instrumentation data) in the parent DR object 202 of the loaded file.

Although the above example is based on two instrumentation data sets, examples disclosed herein may be used to access any number of instrumentation data sets specified in a request from the application 120. For example, the interface circuitry 802 can access third compressed instrumentation data from a third one of the signal data child objects 212a-d of the parent DR object 202 and a second listing of second time values from a second one of the time vectors 208a-c of the parent DR object 202 based on a reference in the request to the parent DR object 202 (e.g., the “DR” reference in the child object access expression 402 of FIG. 4 that references the parent DR object 202). The data decompressor circuitry 806 can decompress the third compressed instrumentation data during the runtime of the application 120 to generate third uncompressed instrumentation data in array-position alignment with the second time values.

FIG. 11 is a flowchart representative of example machine-readable instructions and/or example operations 1100 that may be executed, instantiated, and/or performed by example programmable circuitry to implement the time handler 124 of FIG. 1 to retrieve listings of time values corresponding to uncompressed data. The instructions and/or operations 1100 may be used to implement block 1008 of FIG. 10. In some examples, the instructions and/or example operations 1100 implement a .Time() method to access time values from a time vectors 208a-c of the parent DR object 202. The example instructions and/or operations 1100 begin at block 1102, at which the time handler 124 gets an instrumentation data signal of interest specified in a function input. For example, the request from the application 120 received at block 1006 of FIG. 10 specifies a name or identifier of an instrumentation data signal (e.g., the “AC_CURRENT_1_GENERATOR_PHASE_B” reference in the child object access expression 402 of FIGS. 4 and 5). At block 1104, the time handler 124 determines whether the time handle is empty for the requested instrumentation data. For example, a corresponding one of the DR signal data child objects 212a-d for the instrumentation data signal identifier obtained at block 1102 includes the time handle property 302. In some examples, if the time handle property 302 is empty, the parent DR object 202 includes only a single time vector that applies to all of the instrumentation data sets of the DR signal data child objects 212a-d in the parent DR object 202.

If the time handler 124 determines that the time handle is empty for the requested instrumentation data (block 1104: YES), control advances to block 1106, at which the time handler 124 sets a timeOutput variable to the only time vector in the parent DR object 202 (because there is only one time vector in the parent DR object 202). However, if the time handler 124 determines that the time handle is not empty for the requested instrumentation data (block 1104: NO), control advances to block 1108, at which the time handler 124 sets the timeOutput variable to the time vector pointed to by the time handle in the time handle property 302 (e.g., the time handle ‘Time_1’ of FIGS. 4 and 5) of the corresponding one of the DR signal data child objects 212a-d.

After block 1106 or block 1108, the time handler 124 returns the timeOutput variable (block 1110) to a calling function or process such as the example instructions and/or operations 1000 of FIG. 10. The example instructions and/or operations 1100 of FIG. 11 end.

FIG. 12 is a flowchart representative of example machine-readable instructions and/or example operations 1200 that may be executed, instantiated, and/or performed by example programmable circuitry to implement the JIT data decompressor 104 of FIG. 8 to access uncompressed data. The instructions and/or operations 1200 may be used to implement block 1010 of FIG. 10. For example, the instructions and/or example operations 1200 may implement a .Data( ) method (e.g., a “DR.DATA.AC_CURRENT_1_GENERATOR_PHASE_B. Data” method) to decompress data or access already uncompressed data from a data child object 212a-d of the parent DR object 202. In yet other examples, the instructions and/or example operations 1200 implement any other suitable method that involves accessing uncompressed data.

The instructions and/or operations 1200 begin at block 1202, at which the data decompressor circuitry 806 gets an instrumentation data signal of interest specified in a function input. For example, the request from the application 120 received at block 1006 of FIG. 10 specifies a name or identifier of an instrumentation data signal (e.g., the “AC_CURRENT_1_GENERATOR_PHASE_B” reference in the child object access expression 402 of FIGS. 4 and 5).

At block 1204, the data decompressor circuitry 806 determines whether the instrumentation data of interest corresponding to the instrumentation data signal identified a block 1202 is already decompressed (e.g., uncompressed). For example, the data decompressor circuitry 806 may access the instrumentation data of interest in a corresponding one of the signal data child objects 212a-d of the parent DR object 202. In some examples, the instrumentation data is stored in the parent DR object 202 as uncompressed instrumentation data if the compression of the uncompressed instrumentation data results in a compressed data size that is not smaller than the uncompressed data size of the uncompressed instrumentation data, as described above in connection with blocks 922, 924, 926 of FIG. 9. However, if the compressed data size of the compressed instrumentation data is smaller than the uncompressed data size of the uncompressed instrumentation data, the instrumentation data is stored in the parent DR object 202 as compressed instrumentation data, as described above in connection with blocks 922 and 928 of FIG. 9. In other examples, the data decompressor circuitry 806 may determine at block 1204 that the instrumentation data of interest is already uncompressed because the uncompressed data was previously cached locally in the system memory 126 and is still available.

If the data decompressor circuitry 806 determines that the instrumentation data of interest is not already decompressed (block 1204: NO), control advances to block 1206, at which the data decompressor circuitry 806 performs a decompression function on the compressed instrumentation data. For example, the data decompressor circuitry 806 may perform a run length decoding decompression process based on data packed in the RLE packed values array 304 and corresponding repetition values in the RLE repetition values array 306 of the signal data child object 212a of FIG. 3. At block 1208, the data decompression circuitry 806 stores the uncompressed instrumentation data output of block 1206 in a DecompressedData variable (e.g., the decompressed data array 308 of FIGS. 3-5) in the system memory 126 (FIG. 1). For example, the decompressed instrumentation data may be used by a subsequent method call (e.g., a plot method, a filter method, a modelling method, a statistical analysis method, a mathematical method, a moving average method, etc.) and other future calls until the decompressed instrumentation data is discarded from the system memory 126. In the example of block 1208, the data decompression circuitry 806 causes storing of each uncompressed instrumentation data value in array-position alignment with corresponding time values. Accordingly, the data decompression circuitry 806 causes storing of each uncompressed instrumentation data value in a corresponding data array position of the uncompressed instrumentation data in association with a corresponding time array position of a corresponding time vector. For example, an instrumentation data array position of the uncompressed instrumentation data matches the corresponding time array position of the time values such that instrumentation data array position zero corresponds to time array position zero (e.g., data[0] aligns with time[0]), instrumentation data array position one corresponds to time array position one (e.g., data[1] aligns with time[1]), and so on.

After block 1208, or if the data decompressor circuitry 806 determines that the instrumentation data of interest is already decompressed (block 1204: YES), the data decompressor circuitry 806 returns the DecompressedData variable to a calling function or process (block 1210) such as the example instructions and/or operations 1000 of FIG. 10. The example instructions and/or operations 1200 of FIG. 12 end.

FIG. 13 is a block diagram of an example programmable circuitry platform 1300 structured to execute and/or instantiate the example machine-readable instructions and/or the example operations of FIG. 9 to implement the data compressor 102 of FIG. 7. A separate programmable circuitry platform substantially similar or identical to the programmable circuitry platform 1300 may be used to execute and/or instantiate the example machine-readable instructions and/or the example operations of FIGS. 10-12 to implement the JIT data decompressor 104 of FIG. 8. The programmable circuitry platform 1300 can be, for example, a server, a personal computer, a workstation, a self-learning machine (e.g., a neural network), a mobile device (e.g., a cell phone, a smart phone, a tablet such as an iPad™), or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. When the programmable circuitry platform 1300 implements the data compressor 102 of FIG. 7, the programmable circuitry 1312 implements the core circuitry 704, the deduplicator circuitry 706, the data compressor circuitry 708, the comparator circuitry 710, and the counter circuitry 712 of FIG. 7. When the programmable circuitry platform 1300 implements the JIT data decompressor 104 of FIG. 8, the programmable circuitry 1312 implements the core circuitry 804, and the data decompressor circuitry 806 of FIG. 8.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. When the programmable circuitry platform 1300 implements the JIT data decompressor 104 of FIG. 8, the volatile memory 1314 implements the system memory 126 of FIG. 1. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. When the programmable circuitry platform 1300 implements the data compressor 102 of FIG. 7, the interface circuitry 1320 implements the interface circuitry 702 of FIG. 7.

When the programmable circuitry platform 1300 implements the JIT data decompressor 104 of FIG. 8, the interface circuitry 1320 implements the interface circuitry 802 of FIG. 8.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIGS. 9-12, may be stored in the mass storage device 1328, in the volatile memory 1314, in the non-volatile memory 1316, and/or on at least one non-transitory computer-readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIGS. 7 and 8 as logic circuits to perform operations corresponding to those machine-readable instructions. In some such examples, the circuitry of FIGS. 7 and 8 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to firmware programs, embedded software programs, or software programs may be executed by one of the cores 1402 or may be executed by multiple ones of the cores 1402 at the same or different times. In some examples, the machine code corresponding to the firmware programs, the embedded software programs, or the software programs is split into threads and executed in parallel by two or more of the cores 1402. The software programs may correspond to a portion or all of the machine-readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

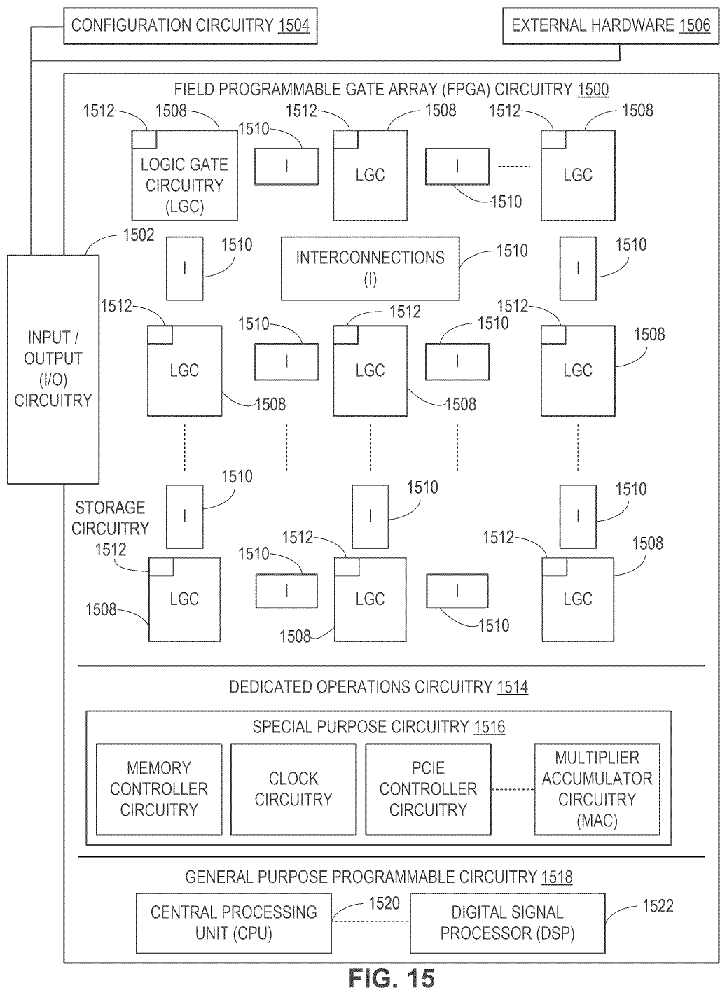

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowcharts of FIGS. 9-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 9-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowcharts) of FIGS. 9-12. As such, the FPGA circuitry 1500 may be configured and/or structured to effectively instantiate some or all of the operations/functions corresponding to the machine-readable instructions of the flowcharts of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, MATLAB, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowcharts of FIGS. 9-12 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIGS. 9-12, and/or an ASIC may be configured and/or structured to perform third operation(s)/function(s) corresponding to a third portion of the machine-readable instructions represented by the flowcharts of FIGS. 9-12.

It should be understood that some or all of the circuitry of FIGS. 7 and 8 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIGS. 7 and 8 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIGS. 7 and 8 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

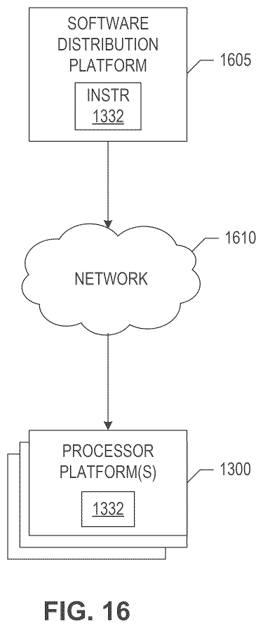

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIG. 9-12, may be downloaded to the example programmable circuitry platform 1300, which is to execute the machine-readable instructions 1332 to implement the data compressor 102 of FIG. 7 and/or the JIT data decompressor 104 of FIG. 8. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software”could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time”refers to being within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that compress and decompress data. Disclosed systems, apparatus, articles of manufacture, and methods improve the efficiency of using a computing device by decreasing the amount of time it takes for the computing device to produce requested uncompressed data. In addition, by selectively decompressing data from a file without decompressing the entire file's data, examples disclosed herein improve the use of computer memory by decreasing the amount of memory used by the file's data when loaded into the memory. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to compress and decompress data are disclosed herein. Further examples and combinations thereof include the following:

Example 1 includes an apparatus comprising interface circuitry to access a listing of time values, and access first compressed instrumentation data and second compressed instrumentation data during a runtime of an application in response to a request from the application, machine-readable instructions, and at least one processor circuit to be programmed by the machine-readable instructions to execute the application, decompress the first compressed instrumentation data during the runtime to generate first uncompressed instrumentation data in alignment with the time values, and decompress the second compressed instrumentation data during the runtime to generate second uncompressed instrumentation data in alignment with the time values.

Example 2 includes the apparatus of example 1, wherein the interface circuitry is to access the first and second compressed instrumentation data from a plurality of child objects of a parent object based on a reference to the parent object, the plurality of child objects to include empty time handle properties when the listing of time values corresponds to both the first and second compressed instrumentation data.

Example 3 includes the apparatus of example 1 and/or example 2, wherein the child objects include third compressed instrumentation data, the interface circuitry is to access the third compressed instrumentation data and a second listing of second time values based on the reference to the parent object, and one or more of the at least one processor circuit to decompress the third compressed instrumentation data during the runtime of the application to generate third uncompressed instrumentation data in array-position alignment with the second time values.

Example 4 includes the apparatus of any one or more of examples 1-3, wherein one or more of the at least one processor circuit is to load a file including the first compressed instrumentation data and the second compressed instrumentation data into memory during the runtime of the application, the file including third compressed instrumentation data, and decompress the first compressed instrumentation data and the second compressed instrumentation data during the runtime of the application without decompressing the third compressed instrumentation data during the runtime.

Example 5 includes the apparatus of any one or more of examples 1-4, wherein one or more of the at least one processor circuit is to decompress the first compressed instrumentation data based on a first data array including instrumentation data values of the first uncompressed instrumentation data and a second data array including run-length repetition values, one of the run-length repetition values representing a number of times that a corresponding one of the instrumentation data values is to occur seriatim in the first uncompressed instrumentation data.

Example 6 includes the apparatus of any one or more of examples 1-5, wherein one or more of the at least one processor circuit is to generate the first uncompressed instrumentation data in alignment with the time values by storing an instrumentation data value in an instrumentation data array position of the first uncompressed instrumentation data in association with a corresponding time array position of the time values.

Example 7 includes the apparatus of any one or more of examples 1-6, wherein the first and second compressed instrumentation data are ones of a plurality of child objects of a parent object, one or more of the at least one processor circuit to decompress the first and second compressed instrumentation data during the runtime of the application without decompressing others of the child objects during the runtime of the application in response to the request from the application specifying the first and second compressed instrumentation data without specifying others of the child objects.

Example 8 includes at least one non-transitory machine-readable medium comprising machine-readable instructions to cause at least one processor circuit to at least compress first uncompressed instrumentation data values to generate first compressed instrumentation data, the first uncompressed instrumentation data values aligned with first time values, after a determination that a compressed data size of the first compressed instrumentation data is not smaller than an uncompressed data size of the first uncompressed instrumentation data values discard the first compressed instrumentation data, and cause storage of the first uncompressed instrumentation data values separate from the first time values, compress second uncompressed instrumentation data values to generate second compressed instrumentation data, the second uncompressed instrumentation data values aligned with second time values, and after a determination that a fourth data size of the second compressed instrumentation data is smaller than a third data size of the second uncompressed instrumentation data values, cause storage of the second compressed instrumentation data separate from the first and second time values.

Example 9 includes the at least one non-transitory machine-readable medium of example 8, wherein the machine-readable instructions are to cause one or more of the at least one processor circuit to create an object-of-objects structure, the object-of-objects structure including first and second child objects in a parent object, the first child object corresponding to the first uncompressed instrumentation data values, the second child object corresponding to the second compressed instrumentation data, and create time handles in the first child object and in the second child object, the time handles to reference the first time values to align with the first uncompressed instrumentation data values and to align with decompressed values of the second compressed instrumentation data.

Example 10 includes the at least one non-transitory machine-readable medium of example 8 and/or example 9, wherein the machine-readable instructions are to cause one or more of the at least one processor circuit to discard the second time values, the second compressed instrumentation data to be stored without storage of the second time values.

Example 11 includes the at least one non-transitory machine-readable medium of any one or more of examples 8-10, wherein the machine-readable instructions are to cause one or more of the at least one processor circuit to compress the second uncompressed instrumentation data values by generating a first data array including ones of the second uncompressed instrumentation data values and a second data array including run-length repetition values, one of the run-length repetition values representing a number of times that a corresponding one of the second uncompressed instrumentation data values occurs seriatim in the second uncompressed instrumentation data values.

Example 12 includes the at least one non-transitory machine-readable medium of any one or more of examples 8-11, wherein the machine-readable instructions are to cause one or more of the at least one processor circuit to cause the storage of the first uncompressed instrumentation data values as a first child object of a parent object, the first child object to include a first time handle to reference the first time values which align with the first uncompressed instrumentation data values, cause the storage of the second compressed instrumentation data as a second child object of the parent object, the second child object to include the first time handle to reference the first time values which align with first decompressed values of the second compressed instrumentation data, and cause storage of third compressed instrumentation data as a third child object of the parent object, the third child object to include a second time handle different from the first time handle, the second time handle to reference second time values which align with second decompressed values of the third compressed instrumentation data.

Example 13 includes the at least one non-transitory machine-readable medium of any one or more of examples 8-12, wherein the machine-readable instructions are to cause one or more of the at least one processor circuit to cause storage of the first uncompressed instrumentation data values, the second compressed instrumentation data, and a single instance of the first time values in one file.

Example 14 includes the at least one non-transitory machine-readable medium of any one or more of examples 8-13, wherein the first uncompressed instrumentation data values are altitude values of aircraft flight data, the second uncompressed instrumentation data values are airspeed values of the aircraft flight data.

Example 15 includes a method comprising creating, by at least one processor circuit programmed by at least one instruction, an object-of-objects structure, the object-of-objects structure including a first child object and a second child object in a parent object, the first child object corresponding to first instrumentation data, the second child object corresponding to second instrumentation data, causing, by one or more of the at least one processor circuit, storage of a first time handle in the first child object, the first time handle to reference first time values, and causing, by one or more of the at least one processor circuit, storage of the first time handle in the second child object.

Example 16 includes the method of example 15, wherein the first time handle is associated with a first property of the first child object and associated with a second property of the second child object.

Example 17 includes the method of example 15 and/or example 16, wherein the first instrumentation data is compressed instrumentation data, the method further including generating the compressed instrumentation data by generating a first data array including packed values and a second data array including run-length repetition values, one of the run-length repetition values representing a number of times that a corresponding one of the packed values occurs seriatim in uncompressed instrumentation data values.

Example 18 includes the method of any one or more of examples 15-17, wherein the first instrumentation data and the second instrumentation data are aircraft flight data.

Example 19 includes the method of any one or more of examples 15-18, wherein the first instrumentation data is altitude data of the aircraft flight data, the second instrumentation data is airspeed data of the aircraft flight data.

Example 20 includes the method of any one or more of examples 15-19, wherein the first instrumentation data is compressed instrumentation data of uncompressed instrumentation data values, the method further including causing storage of the first instrumentation data in association with the first child object and discarding the uncompressed instrumentation data values in response to a compressed data size of the compressed instrumentation data being smaller than an uncompressed data size of the uncompressed instrumentation data values.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry to:
access a listing of time values; and
access first compressed instrumentation data and second compressed instrumentation data during a runtime of an application in response to a request from the application;
machine-readable instructions; and
at least one processor circuit to be programmed by the machine-readable instructions to:
execute the application;
decompress the first compressed instrumentation data during the runtime to generate first uncompressed instrumentation data in alignment with the time values; and
decompress the second compressed instrumentation data during the runtime to generate second uncompressed instrumentation data in alignment with the time values.

2. The apparatus of claim 1, wherein the interface circuitry is to access the first and second compressed instrumentation data from a plurality of child objects of a parent object based on a reference to the parent object, the plurality of child objects to include empty time handle properties when the listing of time values corresponds to both the first and second compressed instrumentation data.

3. The apparatus of claim 2, wherein the child objects include third compressed instrumentation data, the interface circuitry is to access the third compressed instrumentation data and a second listing of second time values based on the reference to the parent object, and one or more of the at least one processor circuit to decompress the third compressed instrumentation data during the runtime of the application to generate third uncompressed instrumentation data in array-position alignment with the second time values.

4. The apparatus of claim 1, wherein one or more of the at least one processor circuit is to:
load a file including the first compressed instrumentation data and the second compressed instrumentation data into memory during the runtime of the application, the file including third compressed instrumentation data; and
decompress the first compressed instrumentation data and the second compressed instrumentation data during the runtime of the application without decompressing the third compressed instrumentation data during the runtime.

5. The apparatus of claim 1, wherein one or more of the at least one processor circuit is to decompress the first compressed instrumentation data based on a first data array including instrumentation data values of the first uncompressed instrumentation data and a second data array including run-length repetition values, one of the run-length repetition values representing a number of times that a corresponding one of the instrumentation data values is to occur seriatim in the first uncompressed instrumentation data.

6. The apparatus of claim 1, wherein one or more of the at least one processor circuit is to store an instrumentation data value in an instrumentation data array position of the first uncompressed instrumentation data in association with a corresponding time array position of the time values.

7. The apparatus of claim 1, wherein the first and second compressed instrumentation data are ones of a plurality of child objects of a parent object, one or more of the at least one processor circuit to decompress the first and second compressed instrumentation data during the runtime of the application without decompressing others of the child objects during the runtime of the application in response to the request from the application specifying the first and second compressed instrumentation data without specifying others of the child objects.

8. At least one non-transitory machine-readable medium comprising machine-readable instructions to cause at least one processor circuit to at least:
compress first uncompressed instrumentation data values to generate first compressed instrumentation data, the first uncompressed instrumentation data values aligned with first time values;
after a determination that a compressed data size of the first compressed instrumentation data is not smaller than an uncompressed data size of the first uncompressed instrumentation data values:
discard the first compressed instrumentation data; and
cause storage of the first uncompressed instrumentation data values separate from the first time values;
compress second uncompressed instrumentation data values to generate second compressed instrumentation data, the second uncompressed instrumentation data values aligned with second time values; and
after a determination that a fourth data size of the second compressed instrumentation data is smaller than a third data size of the second uncompressed instrumentation data values, cause storage of the second compressed instrumentation data separate from the first and second time values.

9. The at least one non-transitory machine-readable medium of claim 8, wherein the machine-readable instructions are to cause one or more of the at least one processor circuit to:
create an object-of-objects structure, the object-of-objects structure including first and second child objects in a parent object, the first child object corresponding to the first uncompressed instrumentation data values, the second child object corresponding to the second compressed instrumentation data; and
create time handles in the first child object and in the second child object, the time handles to reference the first time values to align with the first uncompressed instrumentation data values and to align with decompressed values of the second compressed instrumentation data.

10. The at least one non-transitory machine-readable medium of claim 8, wherein the machine-readable instructions are to cause one or more of the at least one processor circuit to discard the second time values, the second compressed instrumentation data to be stored without storage of the second time values.

11. The at least one non-transitory machine-readable medium of claim 8, wherein the machine-readable instructions are to cause one or more of the at least one processor circuit to compress the second uncompressed instrumentation data values by generating a first data array including ones of the second uncompressed instrumentation data values and a second data array including run-length repetition values, one of the run-length repetition values representing a number of times that a corresponding one of the second uncompressed instrumentation data values occurs seriatim in the second uncompressed instrumentation data values.

12. The at least one non-transitory machine-readable medium of claim 8, wherein the machine-readable instructions are to cause one or more of the at least one processor circuit to:
cause the storage of the first uncompressed instrumentation data values as a first child object of a parent object, the first child object to include a first time handle to reference the first time values to align with the first uncompressed instrumentation data values;
cause the storage of the second compressed instrumentation data as a second child object of the parent object, the second child object to include the first time handle to reference the first time values to align with first decompressed values of the second compressed instrumentation data; and
cause storage of third compressed instrumentation data as a third child object of the parent object, the third child object to include a second time handle different from the first time handle, the second time handle to reference second time values to align with second decompressed values of the third compressed instrumentation data.

13. The at least one non-transitory machine-readable medium of claim 8, wherein the machine-readable instructions are to cause one or more of the at least one processor circuit to cause storage of the first uncompressed instrumentation data values, the second compressed instrumentation data, and a single instance of the first time values in one file.

14. The at least one non-transitory machine-readable medium of claim 8, wherein the first uncompressed instrumentation data values are altitude values of aircraft flight data, the second uncompressed instrumentation data values are airspeed values of the aircraft flight data.

15. A method comprising:
creating, by at least one processor circuit programmed by at least one instruction, an object-of-objects structure, the object-of-objects structure including a first child object and a second child object in a parent object, the first child object corresponding to first instrumentation data, the second child object corresponding to second instrumentation data;
causing, by one or more of the at least one processor circuit, storage of a first time handle in the first child object, the first time handle to reference first time values; and
causing, by one or more of the at least one processor circuit, storage of the first time handle in the second child object.

16. The method of claim 15, wherein the first time handle is associated with a first property of the first child object and associated with a second property of the second child object.

17. The method of claim 15, wherein the first instrumentation data is compressed instrumentation data, the method further including generating the compressed instrumentation data by generating a first data array including packed values and a second data array including run-length repetition values, one of the run-length repetition values representing a number of times that a corresponding one of the packed values occurs seriatim in uncompressed instrumentation data values.

18. The method of claim 15, wherein the first instrumentation data and the second instrumentation data are aircraft flight data.

19. The method of claim 18, wherein the first instrumentation data is altitude data of the aircraft flight data, the second instrumentation data is airspeed data of the aircraft flight data.

20. The method of claim 15, wherein the first instrumentation data is compressed instrumentation data of uncompressed instrumentation data values, the method further including causing storage of the first instrumentation data in association with the first child object and discarding the uncompressed instrumentation data values in response to a compressed data size of the compressed instrumentation data being smaller than an uncompressed data size of the uncompressed instrumentation data values.
